(19) United States
(12) Patent Application Publication
(10) Pub. No.: US 2026/0339526 A1
(43) Pub. Date: Oct. 29, 2026

(54) CONTROLLING ACCESS TO MEMORY BLOCKS

(71) Applicant: Arm Limited, Cambridge (GB)

(72) Inventors: Yuval ELAD, Cambridge (GB); Jason PARKER, Sheffield (GB)

(73) Assignees: Arm Limited, Cambridge (GB); Arm Limited, Cambridge (GB)

(21) Appl. No.: 19/524,940

(22) PCT Filed: Aug. 23, 2024
(86) PCT No.: PCT/GB2024/052217

§ 371 Date: Apr. 1, 2026

(30) Foreign Application Priority Data
Oct. 3, 2023 (GB) 2315125.1

(51) Int. Cl. G06F 3/06

(52) U.S. Cl. CPC G06F 3/0622; G06F 3/064; G06F 3/0673

(57) ABSTRACT

There is provided an issuer apparatus, translation apparatus and access apparatus for providing a secure mechanism for accessing memory. When the issuer requests an address translation for a block of memory, the translation apparatus provides a translated address and a signature. The signature contains the address and a nonce and is signed using a private key that is not known to the issuer. When the issuer accesses the translated address, it provides the signature. The nonce is updated each time the permissions of the block of memory change. Consequently, the signature can be checked for validity when an access request is made. If the nonce is old, then the access request is prohibited. The issuer cannot simply modify the signature because it cannot access the private key. Consequently, memory is kept secure.

The present technique relates to data processing and may have relevance to the area of memory blocks protection.

It is desirable to control access to memory blocks so that only the owning execution environments (e.g. device, processor, virtual machine, application, process, thread, etc.) are able to access them.

Viewed from a first example configuration, there is provided a translation apparatus comprising: translation request receive circuitry configured to receive, from an issuer apparatus, a translation request for addresses used to access a block of a memory; permission check circuitry configured to check permissions associated with the block of memory and produce a determination of whether the issuer apparatus is permitted to access the block of memory; nonce storage circuitry configured to store a nonce in association with the block of memory; and translation response circuitry configured to transmit a response to the translation request with one of the addresses used to access the block of memory and a signature corresponding with a current value of the nonce and the one of the addresses, in response to the determination that the issuer apparatus is permitted to access the block of memory, wherein the nonce is changed in response to permissions of the block of memory being changed.

Viewed from a second example configuration, there is provided a data processing method comprising: receiving, from an issuer apparatus, a translation request for addresses used to access a block of a memory; checking permissions associated with the block of memory; producing a determination of whether the issuer apparatus is permitted to access the block of memory; storing a nonce in association with the block of memory; and transmitting a response to the translation request with one of the addresses used to access the block of memory and a signature corresponding with a current value of the nonce and the one of the addresses, in response to the determination that the issuer apparatus is permitted to access the block of memory, wherein the nonce is changed in response to permissions of the block of memory being changed.

Viewed from a third example configuration, there is provided a computer program for controlling a host data processing apparatus to provide an instruction execution environment comprising: translation request receive program logic configured to receive, from an issuer, a translation request for addresses used to access a general data structure; permission check program logic configured to check permissions associated with the block of memory and produce a determination of whether the issuer is permitted to access the general data structure; a nonce data structure configured to store a nonce in association with the general data structure; and translation response program logic configured to transmit a response to the translation request with one of the addresses used to access the general data structure and a signature corresponding with a current value of the nonce and the one of the addresses, in response to the determination that the issuer is permitted to access the general data structure, wherein the nonce is changed in response to permissions of the general data structure being changed.

Viewed from a fourth example configuration, there is provided an access apparatus comprising: access request receive circuitry configured to receive, from an issuer apparatus, an access request to access a block of memory; signature obtain circuitry configured to obtain a signature for the access request; nonce storage circuitry configured to store a nonce in association with the block of memory; check circuitry configured to perform a check of whether a current value of the nonce matches that used to generate the signature ; and grant circuitry configured to grant access to the block of memory in dependence on the check, wherein the nonce is changed in response to permissions of the block of memory being changed.

Viewed from a fifth example configuration, there is provided a data processing method comprising: receiving, from an issuer apparatus, an access request to access a block of memory; obtaining a signature for the access request; storing a nonce in association with the block of memory; performing a check of whether a current value of the nonce matches that used to generate the signature; and granting access to the block of memory in dependence on the check, wherein the nonce is changed in response to permissions of the block of memory being changed.

Viewed from a sixth example configuration, there is provided a computer program for controlling a host data processing apparatus to provide an instruction execution environment comprising: access request receive program logic configured to receive, from an issuer, an access request to access a general data structure; signature obtain program logic configured to obtain a signature for the access request; a nonce data structure configured to store a nonce in association with the general data structure; check program logic configured to perform a check of whether a current value of the nonce matches that used to generate the signature; and grant program logic configured to grant access to the general data structure in dependence on the check, wherein the nonce is changed in response to permissions of the general data structure being changed.

Viewed from a seventh example configuration, there is provided an issuer apparatus comprising: storage circuitry configured to store, in association with a block of memory, a signature corresponding with the block of memory; and request circuitry configured to issue a memory access request to an access apparatus, wherein the memory access request is to access the block of memory and the memory access request is generated using the signature; the signature has been generated using a private key and a nonce that is specific to the block of memory; and the nonce is changed in response to permissions of the block of memory being changed.

Viewed from an eighth example configuration, there is provided a data processing method comprising: storing, in association with a block of memory, a signature corresponding with the block of memory; and issuing a memory access request to an access apparatus, wherein the memory access request is to access the block of memory and the memory access request is generated using the signature; the signature has been generated using a private key and a nonce that is specific to the block of memory; and the nonce is changed in response to permissions of the block of memory being changed.

Viewed from a ninth example configuration, there is provided a computer program for controlling a host data processing apparatus to provide an instruction execution environment comprising: a signature data structure configured to store, in association with a general data structure, a signature corresponding with the general data structure; and request program logic configured to issue a memory access request to an accessor, wherein the memory access request is to access the general data structure and the memory access request is generated using the signature; the signature has been generated using a private key and a nonce that is specific to the block of memory; and the nonce is changed in response to permissions of the block of memory being changed.

Viewed from a tenth example configuration, there is provided an apparatus comprising: signature obtain circuitry configured to obtain a first payload and a second payload; check circuitry configured to generate a Message Authentication Code from the first payload and the second payload; and packet generation circuitry configured to generate a packet comprising the first payload and the Message Authentication Code while omitting the second payload.

Viewed from an eleventh example configuration, there is provided a data processing method comprising: obtaining a first payload and a second payload; generating a Message Authentication Code from the first payload and the second payload; and generating a packet comprising the first payload and the Message Authentication Code while omitting the second payload.

Viewed from a twelfth example configuration, there is provided a computer program for controlling a host data processing apparatus to provide an instruction execution environment comprising: obtaining program logic configured to obtain a first payload and a second payload; first generating program logic configured to generate a Message Authentication Code from the first payload and the second payload; and second generating program logic configured to generate a packet comprising the first payload and the Message Authentication Code while omitting the second payload.

Viewed from a thirteenth example configuration, there is provided an apparatus comprising: packet obtaining circuitry configured to receive a packet comprising a first payload and a Message Authentication Code; signature obtain circuitry configured to obtain a second payload for the packet; and check circuitry configured to check that the Message Authentication Code is generated using the first payload and the second payload, wherein the second payload is omitted from the packet.

Viewed from a fourteenth example configuration, there is provided a data processing method comprising: receiving a packet comprising a first payload and a Message Authentication Code; obtaining a second payload for the packet; and checking that the Message Authentication Code is generated using the first payload and the second payload, wherein the second payload is omitted from the packet.

Viewed from a fifteenth example configuration, there is provided a computer program for controlling a host data processing apparatus to provide an instruction execution environment comprising: packet obtaining program logic configured to receive a packet data structure comprising a first payload and a Message Authentication Code; signature obtain program logic configured to obtain a second payload for the packet data structure; and check program logic configured to check that the Message Authentication Code is generated using the first payload and the second payload, wherein the second payload is omitted from the packet.

The present technique will be described further, by way of example only, with reference to embodiments thereof as illustrated in the accompanying drawings, in which:

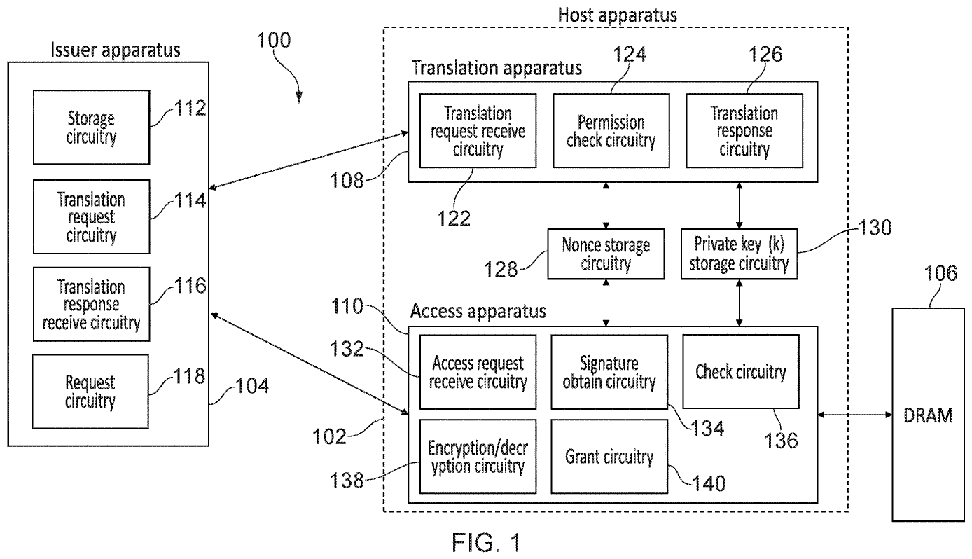

FIG. 1 illustrates a system in accordance with some examples;

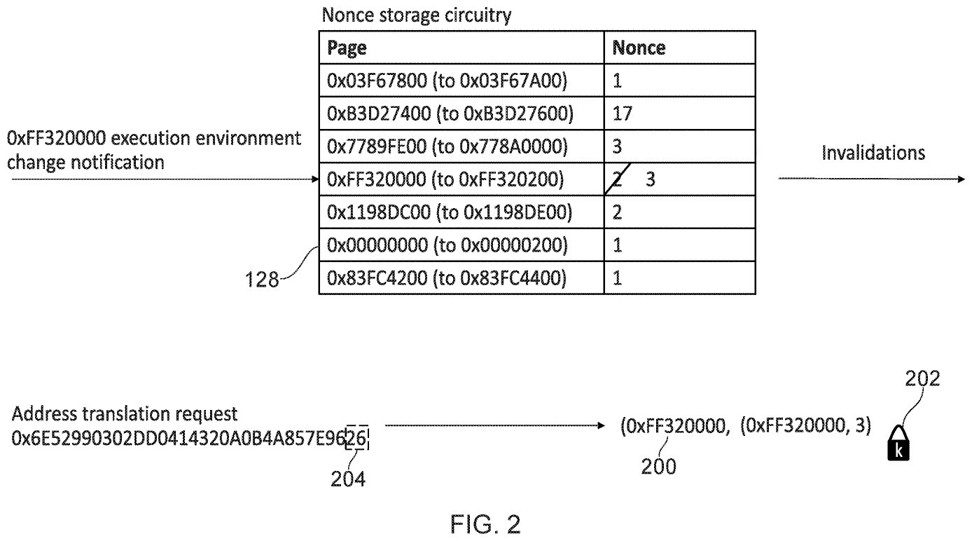

FIG. 2 illustrates example behaviour of the process of changing the nonces;

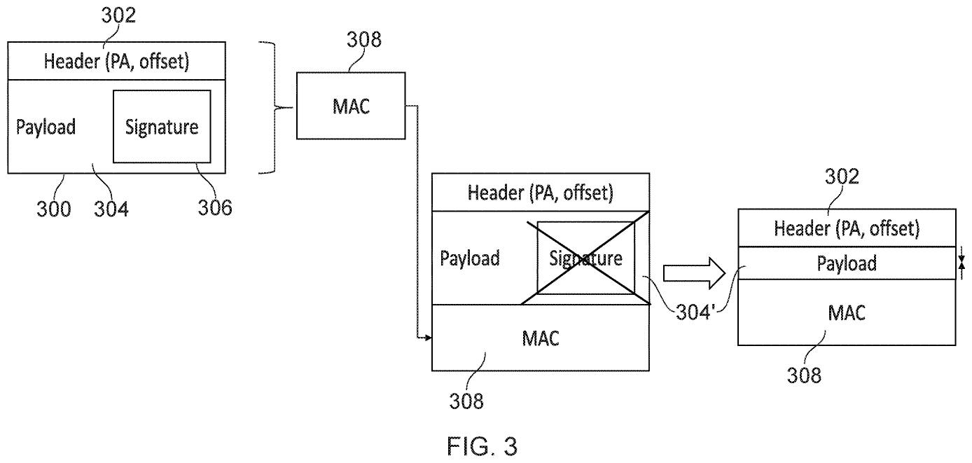

FIG. 3 illustrates a process that makes it possible for the signature to be implicitly included in the memory access request;

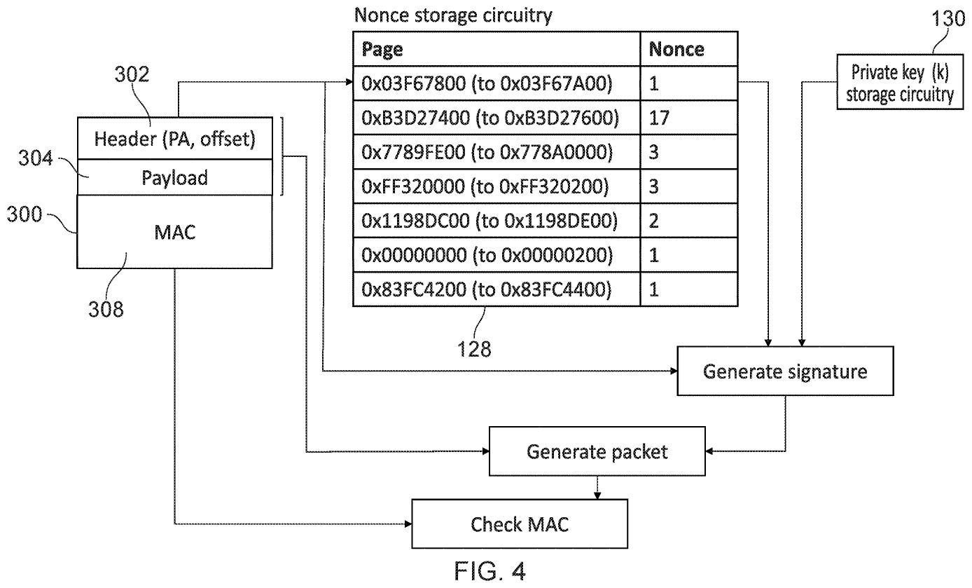

FIG. 4 illustrates how such a memory access request packet can be received and the signature can be implicitly obtained;

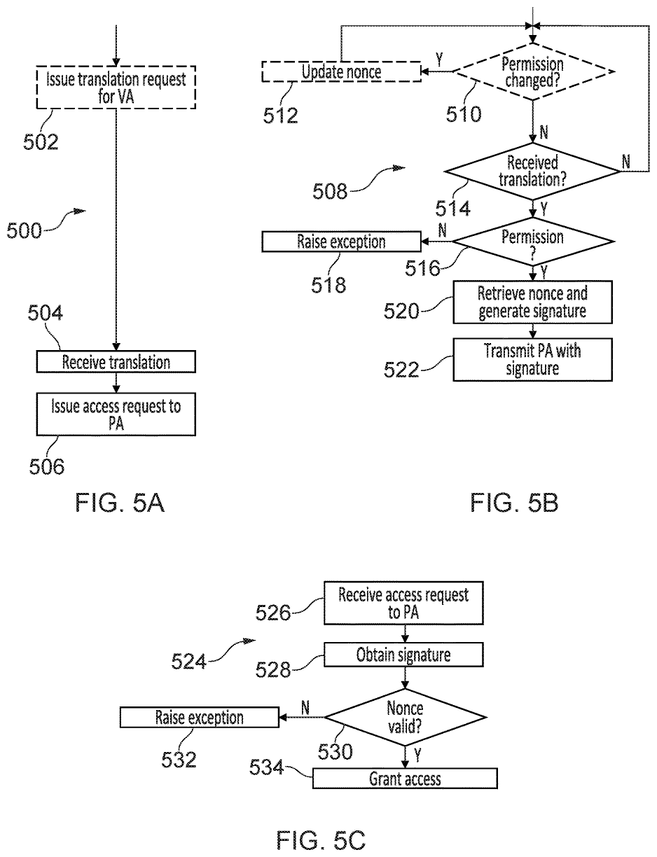

FIGS. 5A, 5B, and 5C illustrates a series of flowcharts that show methods of data processing in accordance with some examples;

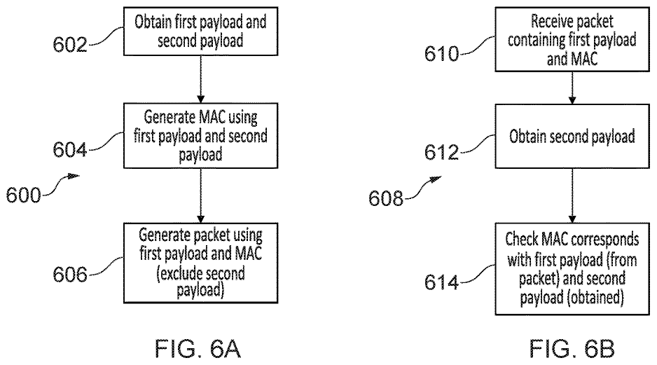

FIGS. 6A and 6B illustrate a process of data processing in accordance with some examples; and

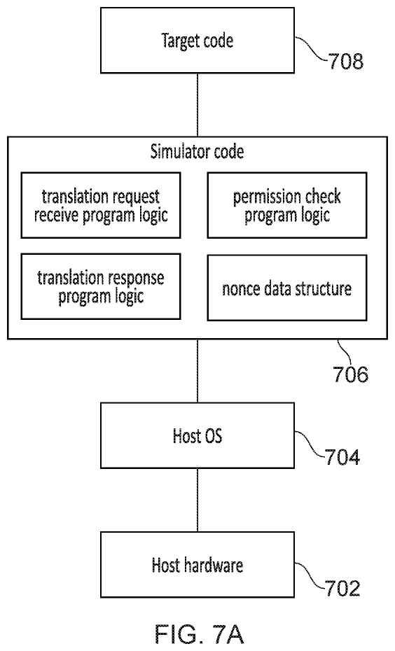

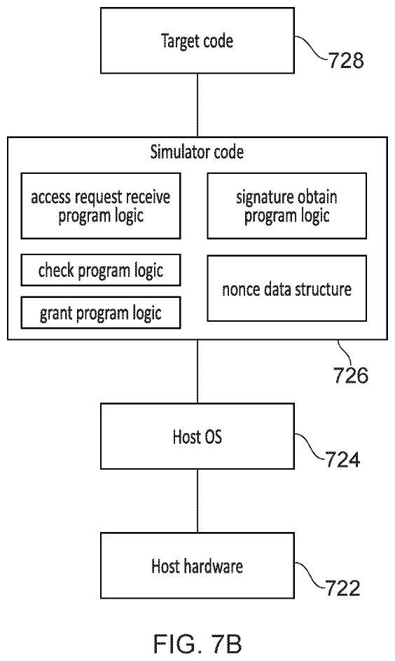

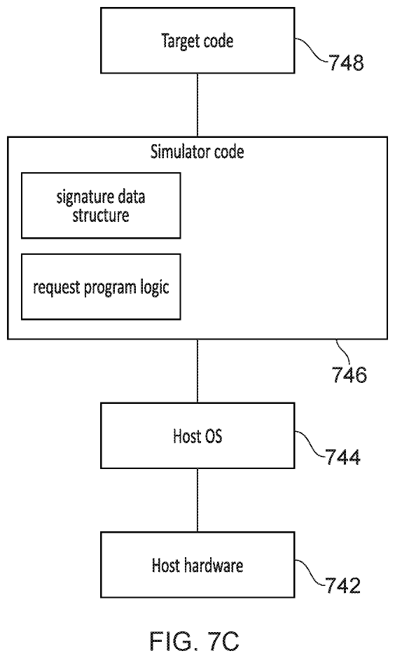

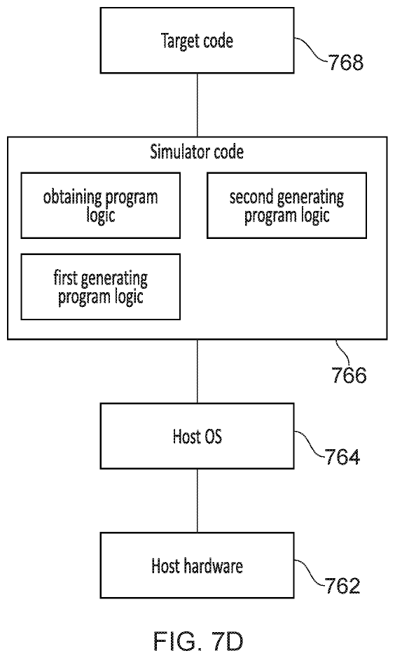

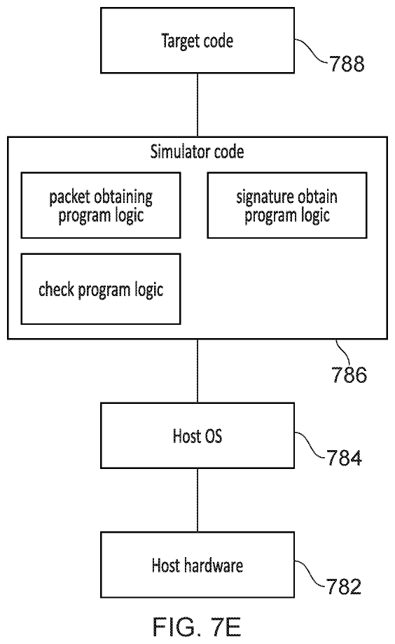

FIGS. 7A, 7B, 7C, 7D, and 7E illustrate simulator implementations that may be used.

Before discussing the embodiments with reference to the accompanying figures, the following description of embodiments and associated advantages is provided.

In accordance with one example configuration there is provided translation apparatus comprising: translation request receive circuitry configured to receive, from an issuer apparatus, a translation request for addresses used to access a block of a memory; permission check circuitry configured to check permissions associated with the block of memory and produce a determination of whether the issuer apparatus is permitted to access the block of memory; nonce storage circuitry configured to store a nonce in association with the block of memory; and translation response circuitry configured to transmit a response to the translation request with one of the addresses used to access the block of memory and a signature corresponding with a current value of the nonce and the one of the addresses, in response to the determination that the issuer apparatus is permitted to access the block of memory, wherein the nonce is changed in response to permissions of the block of memory being changed.

The translation apparatus may form part of a PCIe host apparatus and may be responsible for translating memory addresses—e.g. from a first domain to a second domain such as from a virtual address to a physical address or intermediate physical address. Such an address translation can pre-empt a memory access request to the memory. Having received the translation request, the permission check circuitry then determines whether the requester has permission to access the block of memory to which the provided address relates. A response to the translation request can then be provided, with the translation response containing the translated address (e.g. the physical address). The translated address is provided in a signed form as well (the signature), the signature having been produced using a private key and a nonce (number used once). The nonce is specific to the block of memory in question and is updated each time the permissions for the block of memory change. Since the signature is produced using a private key, it cannot be replicated by an unauthorised device. Furthermore, since the signature contains the nonce, it is possible to determine the value of the nonce at the time the translation was given. If the nonce in the signature matches the current nonce then the address translation (also in the signature) is valid. Otherwise, the translated address is old-the permissions have since changed- and is no longer valid (the requester may no longer be able to access the block of memory). In this way, it is possible to couple the address translation with a ‘self destruct’ mechanism that can cause the translation to be invalided (e.g. when permissions change). By requiring the accessor/issuer to prove that they have a valid signature for an address, it is possible to control how the address is used. The granularity of the permissions is dependent on the underlying system. For instance, permissions might be granted depending on the underlying application. In other examples, permissions might be granted depending on a virtual machine identifier, a machine identifier, or even an identifier used to identify a group of physical devices.

In some examples, the block of memory is a page of memory. Each nonce can be provided on a page-by-page basis thereby making it possible to control (on a page-by-page basis) which execution environment(s) (applications, devices, virtual machines, processors, physical devices, etc.) are permitted to access that block of memory.

In some examples, the nonce takes the form of a counter, which is changed in response to permissions of the block of memory being changed by incrementing the counter. For example, each time the permissions of the block of memory are changed, the counter might be incremented. Until the counter is reset (e.g. due to overflow), this should prevent the same nonce being used twice. In some other embodiments, the nonce can be assigned randomly each time it is changed. This removes the need for addition circuitry, but can result in the nonce being used twice. One way of preventing this from happening is to increase the number of bits used to generate the nonce.

In some examples, the permissions of the block of memory being changed, that cause the nonce to be changed, are an ownership of the block of memory being changed. The permission in question could therefore be an owner of the block of memory, with the owner having full permission over that block of memory to read and/or write as desired.

In some examples, the signature is generated by performing a first one-way hash on the nonce and one of the addresses. A hash function can be considered to be a function that takes an input in an input domain and produces an output in an output domain, with the output domain being the same or smaller than the input domain. In a one-way hash function, the process cannot be reversed in order to determine the input from the output. For example, a hash function that reverses the input to produce an output is not a one-way hash because the process can be reversed. The one-way hash is performed on a combination of the nonce and one of the addresses (e.g. the virtual address or the physical address). In some examples, the one-way hash is performed on the combination of the nonce and the physical address. The combination may be achieved by concatenation of the two elements, for instance.

In some examples, the first one-way hash is cryptographic. In a cryptographic hash, it is computationally intractable to generate a valid input that produces the same output without at least some of the parameters used to generate the result. That is, one essentially cannot determine what the input is, given the output from the hash function without for instance, the private key used in the hash function. With the private key, it may be trivial to reverse the generation.

In some examples, the translation response circuitry is configured to respond to a plurality of translation requests for the address from a plurality of issuer apparatuses by performing a plurality of checks on the permissions for the plurality of the issuer apparatuses, and transmitting the responses based on which of the issuer apparatuses is permitted to access the block of memory. The translation apparatus can therefore handle a plurality of issuer apparatuses.

In accordance with another example configuration, there is provided an access apparatus comprising: access request receive circuitry configured to receive, from an issuer apparatus, an access request to access a block of memory; signature obtain circuitry configured to obtain a signature for the access request; nonce storage circuitry configured to store a nonce in association with the block of memory; check circuitry configured to perform a check of whether a current value of the nonce matches that used to generate the signature; and grant circuitry configured to grant access to the block of memory in dependence on the check, wherein the nonce is changed in response to permissions of the block of memory being changed.

The access apparatus is responsible for receiving the access request after the previously discussed address translation has taken place and could form part of a larger host apparatus together with the translation apparatus. The issuer apparatus issues its access request to access a block of memory and the signature obtain circuitry obtains a signature used to generate the access request. There are a number of ways in which this can be achieved, as will be illustrated below but importantly the signature need not be in the access request itself (although it may be). The access apparatus includes nonce storage circuitry that includes the nonces associated with the blocks of memory. This could be shared with the translation apparatus (or other devices) or could be dedicated. The check circuitry is then used to determine whether the current value of the nonce (e.g. that is stored in the nonce storage circuitry) for the memory block is the same as that used to generate the signature that has been obtained. If so, then the grant circuitry grants the requested access (e.g. returns the data in the case of a read and stores the data in the case of a write). The nonce is changed when the permissions of the block of memory are changed and so the access request indicates the state of the permissions when the translation for an address of the memory block was provided.

In some examples, the access apparatus comprises: encryption circuitry configured to encrypt data in the access request using the nonce, to produce encrypted data and to write the encrypted data to the block of memory in dependence on the check. As well as using the nonce to control access to the block of memory by requiring the existence of a signature (generating using the nonce) to access the block of memory, the nonce can also be used as a key or tweak for performing encryption of data within the block of memory. Consequently, when the permissions for the block of memory change, the data is automatically invalidated (e.g. rendered unreadable) due to the key having changed. The encryption can be improved when the nonce is randomised so that it is not possible to recover the old version of the key. Since the nonce is used for the key (either as the key itself or as a tweak to a key), which is not provided in an unencrypted form to issuers, it is not possible for issuers or another apparatus to directly access the data stored in the block of memory. The data will be unintelligible due to the encryption (and any writing of data will also lead to data that cannot be read).

In some examples, the access apparatus comprises: decryption circuitry configured to decrypt data retrieved from the block of memory using the nonce to produce decrypted data in dependence on the check. Similarly to the encryption circuitry, the nonce can be used to decrypt data that is retrieved from memory, in response to a write memory access request. If the data was encrypted using the same nonce then the returned data is intelligible, otherwise it is not and the request returns unintelligible data. This can be prevented by the issuer apparatus following the supplied invalidation requests, as will be discussed below in respect of the issuer apparatus. Note that the decryption circuitry and the encryption circuitry could be the same component or could share components in order to reduce circuit size.

In some examples, the access request comprises an address of the block of memory, and the signature; and the signature obtain circuitry is configured to obtain the signature from the access request. One way in which the signature can be obtained it by reading it from the access request itself. That is, the access request contains the signature, and this is read by the access apparatus to confirm its validity. Although this approach is secure, it does necessitate the sending of the signature in each memory access request, which increases the overhead and bandwidth consumption.

In some examples, the signature is generated by performing a first one-way hash on an address of the memory block and the nonce, using a private key. As previously explained, a one-way hash is a hash function in which the process cannot be reversed in order to determine the input from the output. Note that in some examples, the access apparatus itself does not generate the signature, which may instead be provided as part of the access request itself.

In some examples, the access apparatus comprises: storage circuitry configured to store the private key. The storage circuitry need not be part of the access apparatus itself and need not be dedicated to the access apparatus. In some embodiments, the access apparatus is shared with another apparatus or could be shared among a number of devices.

In some examples, the one-way hash is cryptographic. As explained above, a cryptographic hash function makes it computationally intractable to generate a valid input that produces the same output without at least some of the parameters used to generate the output. That is, in the current examples, without the private key and/or the nonce, it is not possible to determine an input that will produce the same output result.

In some examples, the signature obtain circuitry is configured to obtain the signature implicitly from the access request. There is no need for the signature to be included in the access request in order to verify (with relative certainty) that the issuer is in possession of the signature. In these examples, the access apparatus is able to imply that the issuer has the signature for the access request without it being transmitted as part of the access request. This makes it possible to provide security without a significant increase in bandwidth consumption.

In some examples, the access request received by the access request receive circuitry comprises an address of the block of memory and a Message Authentication Code, and omits the signature; the Message Authentication Code is generated by performing a second one-way hash on access request variant comprising the address of the block of memory and the signature. A Message Authentication Code is obtained by performing a second hash function (different to the first hash function) on the contents of (typically) a message to be transmitted. By re-forming this second hash function on the contents it is possible to check whether the contents have changed (e.g. due to a transmission error during transmission). In these examples, the MAC can be used to imply ownership of the signature by the issuer without the signature actually being sent.

In some examples, the check circuitry is configured to perform the check by producing a test signature from the address of the block of memory and the nonce and by testing whether the Message Authentication Code corresponds with a result of performing the second one-way hash on the address of the block of memory and the test signature. The MAC is generated at the issuer apparatus with the signature being present and then the signature is removed prior to transmission. By regenerating the signature at the access apparatus, and testing that the MAC in the packet is valid when the regenerated MAC is inserted, it is possible to determine whether the MAC was generated while the signature was present at the issuer. Without having the signature, it is generally not possible to generate a MAC that corresponds with contents including the signature. Thus, if the MAC is correct (using the generated signature at the access apparatus) then it can be implied that the issuer had the same signature. If the signature has changed then the MAC will not be correct.

In some examples, the access apparatus comprises: cache circuitry configured to cache the result. Rather than actually regenerating the signature each time an access request is received (which can be time consuming) the signatures can be cached. This could either be done the first time that any access request is received where the corresponding signature is not present, or it could be cached when the signature is generated by the translation apparatus-with the signature being made available to the access apparatus.

In some examples, the block of memory is a page of memory. Permissions can therefore be controlled on a page-by-page basis.

In some examples, the nonce takes the form of a counter, which is changed in response to permissions of the block of memory being changed by incrementing the counter. For example, each time the permissions of the block of memory are changed, the counter might be incremented. Until the counter is reset (e.g. due to overflow), this should prevent the same nonce being used twice. In some other embodiments, the nonce can be assigned randomly each time it is changed. This removes the need for addition circuitry, but can result in the nonce being used twice. One way of preventing this from happening is to increase the number of bits used to generate the nonce. In some examples, the permissions of the block of memory being changed, that cause the nonce to be changed, are an ownership of the block of memory being changed. The permission in question could therefore be an owner of the block of memory, with the owner having full permission over that block of memory to read and/or write as desired.

In some examples, there is an apparatus including one of the above-mentioned translation apparatuses and one of the above-mentioned access apparatuses. These might form, for instance, a host apparatus. Circuits that perform similar functionality can be shared rather than being duplicated. For instance, the nonce storage circuitry need not be provided twice.

In accordance with another example configuration, there is provided an issuer apparatus comprising: storage circuitry configured to store, in association with a block of memory, a signature corresponding with the block of memory; and request circuitry configured to issue a memory access request to an access apparatus, wherein the memory access request is to access the block of memory and the memory access request is generated using the signature; the signature has been generated using a private key and a nonce that is specific to the block of memory; and the nonce is changed in response to permissions of the block of memory being changed.

The issuer apparatus is responsible for issuing the memory access requests in the overall system. The request circuitry is responsible for issuing the memory access request (e.g. a read or write request) for a block of memory. The issuer apparatus in these examples has the access address (e.g. a physical address) and a signature for the access address. This may have been obtained using an address translation request (discussed below) or through other means. Regardless, when the request is made, the access request is generated using (but not necessarily including) the signature. Thus, it is possible to determine (or at least infer) that the issuer apparatus had the signature. If that signature matches the current signature, then the access request remains valid. The signature is generated (e.g. by a device other than the issuer) using a private key that is not available to the issuer as well as a nonce. The nonce is used to enforce currency and is changed whenever permissions of the memory block are changed. Therefore when the permissions change, the signature held by the issuer will no longer be valid. Since the signature is generated using a private key not available to the issuer, the issuer cannot simply recreate the signature using the new nonce (and indeed, the value of the nonce might not be available to the issuer in any event). In practice, an issuer is encouraged to delete old signatures as part of receiving an invalidation request. That is, when permissions change for a block of memory, an invalidation request will be sent to the issuer apparatus in relation to the at least one of the addresses used to access that block of memory. In response to the invalidation request, the issuer apparatus should delete any related cached translations. However, the issuer apparatus should also delete any existing signatures that are stored in relation to the translation. In the future, if the access apparatus wishes to re-access the memory block, it obtains the new signature (which has changed due to the permissions change) if it is still permitted to access the memory block and uses the new signature in the memory access request.

In some examples, the request circuitry is configured to generate the memory access request using the signature by including the signature in the request. As previously explained, one way in which the signature can be used in the memory access request is by including it in the request, which is then extracted by the access apparatus.

In some examples, the request circuitry is configured to generate the memory access request using the signature by generating a Message Authentication Code based on the memory access request including the signature; and the request circuitry is configured to transmit the memory access request including the Message Authentication Code and omitting the signature. As previously explained, an alternative to the signature being included within the memory access request is for the MAC code of a packet to be generated as if the signature was present, but for the signature to be omitted from the packet (e.g. when it is transmitted to the access apparatus). If the signature has not changed, then the access apparatus is able to infer that the issuer apparatus had the signature at the time the access request was sent.

In some examples, the block of memory is a page of memory. Access can therefore be controlled on a page-by-page basis.

In some examples, the nonce takes the form of a counter, which is changed in response to permissions of the block of memory being changed by incrementing the counter. For example, each time the permissions of the block of memory are changed, the counter might be incremented. Until the counter is reset (e.g. due to overflow), this should prevent the same nonce being used twice. In some other embodiments, the nonce can be assigned randomly each time it is changed. This removes the need for addition circuitry, but can result in the nonce being used twice. One way of preventing this from happening is to increase the number of bits used to generate the nonce.

In some examples, the permissions of the block of memory being changed, that cause the nonce to be changed, are an ownership of the block of memory being changed. The permission in question could therefore be an owner of the block of memory, with the owner having full permission over that block of memory to read and/or write as desired.

In some examples, the issuer apparatus comprises: translation request circuitry configured to transmit, to a translation apparatus, a translation request for addresses used to access the block of memory; and translation response receive circuitry configured to receive an address used to access the block of memory and the signature. One way in which the signature can be obtained is as part of a translation request for addresses used to access the block of memory. That is, in obtaining the response to the memory translation request if the issuer is permitted to access the block of memory then a signature will be provided as well as a translated address (e.g. a physical address) for the block of memory. In the event that the issuer apparatus is not permitted to access the memory block, the translation request does not provide the signature (or the translation) and may respond with an error or may raise an exception.

In some examples, the signature is generated by performing a one-way hash on an address of the memory block and the nonce, using the private key. As previously explained in a one-way hash function, the process cannot be reversed in order to determine the input from the output. For example, a hash function that reverses the input to produce an output is not a one-way hash because the process can be reversed. The one-way hash is performed on a combination of the nonce and one of the addresses (e.g. the virtual address or the physical address). In some examples, the one-way hash is performed on the combination of the nonce and the physical address. The combination may be achieved by concatenation of the two elements, for instance.

In some examples, the one-way hash is cryptographic. In a cryptographic hash, it is computationally intractable to generate a valid input that produces the same output without at least some of the parameters used to generate the result. That is, one essentially cannot determine what the input is, given the output from the hash function without for instance, the private key used in the hash function. With the private key, it may be trivial to reverse the generation.

In accordance with another example configuration, there is provided an apparatus comprising: signature obtain circuitry configured to obtain a first payload and a second payload; check circuitry configured to generate a Message Authentication Code from the first payload and the second payload; and packet generation circuitry configured to generate a packet comprising the first payload and the Message Authentication Code while omitting the second payload.

In the above examples, it is possible to transmit a packet that allows the inference that the second payload is present without the second payload actually being transmitted. This makes it possible to verify that a user has the second payload without consuming bandwidth in transmitting that second payload. This can be particularly useful in security scenarios where it is necessary to demonstrate that the sender has a token or signature, e.g. granting access to some resource. The process works by relying on the Message Authentication Code which produces a signature or digest of a set of input data. In most cases, any modification to the input data produces a large change in the Message Authentication Code. It may also be computationally intractable to find two inputs that generate the same output. Consequently, unless the sender actually has the second payload, it is impractical for them to generate and send a Message Authentication Code that has been generated using the second payload. The first payload is used to add variance to the Message Authentication Code and essentially acts as a ‘seed’. In particular, the first payload could be set to null (or be an empty string) meaning that the Message Authentication Code would be based solely on the second payload. However, this does not prevent replay attacks because the same packet would be repeatedly generated.

In accordance with another example configuration, there is provided An apparatus comprising: packet obtaining circuitry configured to receive a packet comprising a first payload and a Message Authentication Code; signature obtain circuitry configured to obtain a second payload for the packet; and check circuitry configured to check that the Message Authentication Code is generated using the first payload and the second payload, wherein the second payload is omitted from the packet. The receiver of the packet mentioned in the above paragraph can infer the presence of the second payload at the sender by obtaining the second payload for the packet (e.g. from an alternative source). This is then used with the first payload to regenerate the Message Authentication Code. The result is compared with the Message Authentication Code provided in the received packet. If the two are the same, then the packet that was received has a Message Authentication Code that would have required the second payload to have been present. This can therefore be used to infer that the packet was present at the sender. In practice, of course, further analysis of the first payload may be required to prevent replay attacks. That is, the first payload should ideally be unique in order to determine that the Message Authentication Code was newly generated using the signature rather than having been copied from another source. This can be achieved by having a table of previously sent first payloads or a counter that is incremented at each communication for instance. Other techniques will of course be known to the skilled person.

Particular embodiments will now be described with reference to the figures.

FIG. 1 illustrates a system 100 made up from a host apparatus 102 and an issuer apparatus 104. The host apparatus 102 is connected to a memory such as a DRAM 106. The issuer apparatus 104 may take the form of a PCIe device such as an end point device or an address translation cache device. The host apparatus may take the form of or be implemented at a root port and may take the form of a translation agent. In this example, the host apparatus 102 is made up of a translation apparatus 108 and an access apparatus 110.

The issuer apparatus 104 includes translation request circuitry 114, which is used to obtain an address translation for a block (e.g. a page) of memory. For instance, the translation process might translate a virtual address to a physical address (or an intermediate physical address). A response to this is received and processed by the translation response receive circuitry 116. In this example, as well as the translation, a signature of the translation is also received. The signature is achieved by the application of a private key k (held at the host apparatus 102) using a one-way hash function (e.g. a cryptographic hash function). As will be explained later, the signature is such that it remains valid as long as the permissions for the page of memory remain the same. Therefore if ownership of the page changes, the translation becomes invalid.

The translated address and the signature are stored in storage circuitry 112 of the issuer apparatus 104.

When a memory access request (e.g. a request to read or write to memory) is made by the request circuitry 118, the request includes the signature, thereby validating the right for the issuer apparatus 104 to access the memory location.

Meanwhile, translation request receive circuitry 122 of the translation apparatus 108 receives the translation request sent by the translation request circuitry 114 of the issuer apparatus 104. Permission check circuitry checks that the issuer 104 is permitted to access the requested area of memory. If no permission is granted then either no response is provided or a rejection response is transmitted. Otherwise, a translation is provided by the translation response circuitry 126. In these examples, as well as providing the translated address, a signature is also provided. The signature is obtained by performing a one-way or cryptographic hash on a value of the translated address in combination with a nonce that is unique to each block or page of memory. The hash is performed using a private key (k). The nonces are stored in the nonce storage circuitry 128 and the private key is stored in the private key storage circuitry 130.

Typically, the address translation request is made in respect of the block or page of memory and the eventual memory access can provide an offset into the block or page of memory that is to be accessed. It is therefore possible to cache the signature for each block of memory—e.g. in the nonce storage circuitry—so that the signature need not be calculated repeatedly.

The access apparatus 110 handles the eventual memory access request (read or write) from the issuer apparatus 104. The request is received by access request receive circuitry 132. The request will contain a memory address to the memory block or page to be accessed. From there, a signature for the memory block or page can be obtained by the signature obtain circuitry 134. There are a number of ways in which this can be done, as will be illustrated with respect to FIGS. 3 and 4. Check circuitry 136 checks that the signature is valid and current. That is, if a new signature produced for the same memory address and using the key in the private key storage circuitry 130 and the latest version of the nonce stored in the nonce storage circuitry 128 produces the same signature obtained by the signature obtain circuitry, then the signal is considered to be current and valid. Consequently, grant circuitry 140 will grant the requested access. Otherwise, grant will not be provided. This can be effected by either a lack of response (or acknowledgement), a failed acknowledgement (NAK) or an error such as an exception being raised. The access apparatus 110 also contains encryption/decryption circuitry 138 that can be used to encrypt/decrypt access requests. For instance, in some embodiments, the contents of the memory pages themselves are encrypted using (e.g.) the nonce or a signature of the page (the access address of the page, encrypted using the private key k and a current nonce value). The encryption/decryption circuitry 138 can therefore be used to either decrypt data retrieved from the memory 106 before it is sent back to the issuer 104 in response to a read access request, or it can be used to encrypt data provided from the issuer 104 in response to a write request, before being written to the memory 106.

The nonces are provided on a per-block or per-page basis and are changed each time permissions of the associated block or page are changed. Consequently, if the permissions change (e.g. the owner of the block or page changes) then the nonce changes and the check circuitry 136 will report that the obtained signature differs from what the signature should currently be. Access will therefore not be granted.

Note that in this example, the translation apparatus 108 and the access apparatus 110 collectively form a single unit—the host 102. However, this is not essential and the two elements can be entirely separate. Furthermore, the translation apparatus 108 and the access apparatus 110 are shown to share nonce storage circuitry 128 and private key (k) storage circuit 130. However, the translation apparatus 108 and the access apparatus 110 could each store their own nonce storage circuitry 128 and private key (k) storage circuitry 130, the master version of which could be stored elsewhere.

The permission check circuitry 124 and/or the check circuitry 136 could be or form parts of an SMMU or an IOMMU.

FIG. 2 illustrates example behaviour of the nonce storage circuitry 128 and particularly the process of changing the nonces. In this example, the nonces take the form of counters, because this helps to ensure that each nonce is used only once. In alternative embodiments, the nonces could be randomised, particularly if the width of the nonce values is sufficiently high. This can be simpler, but can also run the risk of the same nonce value being used twice in a short space of time.

In this example, a change in the execution environment owner of the memory page 0xFF320000 occurs. The execution environment could be a physical machine, a virtual machine, a processor, a realm (e.g. from non-secure to secure or to one of the realms, or to root), an operating system, an application, or any other environment in which a series of instructions can be executed in an encapsulated area. Here, we are not concerned with the specifics of what exactly has changed but we are instead concerned with the fact that the change has occurred. This causes a nonce (in this example, a counter) associated with that memory page to be incremented.

FIG. 2 also shows an example address translation request that is being made. Here, a virtual address is provided as part of the translation request. It is determined that the requester has permission to access the memory page to which the virtual address points. Therefore, a physical address 200 for the memory page is provided, together with a corresponding signature 202.

The signature is the result of applying a cryptographic hash (using private key ‘k’) to the physical address of the page and the current nonce value (now incremented to 3). Examples of cryptographic hash functions include SHA and DSA.

When a memory access is to be made, the signature must be provided. If the nonce increases in the meantime (because the ownership changes), then the newest version of the signature will not match the signature provided by the issuer. Consequently, the memory access will fail. Since the nonce is part of the signature, the issuer cannot simply adjust the nonce itself because it does not have access to the private key ‘k’. Meanwhile, the issuer cannot simply provide another signature. Even if the nonce value was valid, the physical address would not match. Again, because the issuer does not have access to the private key ‘k’, the issuer cannot adjust the signature to apply to a different physical address with the same nonce.

Note that in practice, the translation request might include a full virtual address including an offset 204 into the memory page. Despite this, the response provided by the translation apparatus 108 is to the memory page containing the physical address to which the full virtual address points.

In addition to the nonce being changed, an invalidation request (a TLBI) is transmitted to other devices that might have cached the nonce, thereby causing them to delete their (now incorrect) cached value and/or to replace it with the new value. The regular invalidation techniques (e.g. as defined by ATC) can also be used to invalidate the translation stored by the issuer apparatus 104, thereby causing the entry in the storage circuitry 112 (containing the translation and the signature) to be deleted. When the translation is required again in the future, this can be achieved by a further translation request (which can be accepted or rejected based on the new permissions). If the issuer apparatus 104 chooses to (illegally) keep the signature, it will not work because it will not be produced using the new version of the nonce.

For simplicity, this description describes the process that occurs between one host apparatus 102 and one issuer apparatus 104. In practice, the host apparatus may deal with a number of issuer apparatuses. Multiple issuer apparatuses can share access to a memory page or block by simply distributing the signature to all issuers that have and need access.

In practice, the owning execution environment of a memory page can be specified at any level of granularity. For instance, the execution environment might be specified as a processor, a virtual machine, a realm, an application, a thread, and so on. This can be implemented by the issuer apparatus 104 being a virtualizable device that is composed of multiple logical interfaces/entities that can be assigned to different execution environments. In these situations, it is the responsibility of the issuer apparatus 104 to ensure that an interface assigned to one execution environment (e.g. an application) cannot use an address or signature that was granted to an interface assigned to another execution environment. Such techniques will be implementable by the skilled person. In the situation where usage of an interface (and its associated memory pages) changes from, for instance, one virtual machine to another virtual machine then the signature will change and will need to be reobtained-possibly by the same issuer apparatus 104.

FIG. 3 illustrates a process carried out by (for example) the request circuitry 118 of the issuer apparatus 104 that makes it possible for the signature to be implicitly included in the memory access request and obtained by the signature obtain circuitry 134. FIG. 3 illustrates the memory access request packet 300 containing a header 302 (which contains the physical address of the page being accessed and an offset into that page that is being accessed). The packet 300 also contains a payload 304 that in this case contains the signature 306 for the physical address.

These contents are used to generate a Message Authentication Code (MAC) 308. There are a number of techniques that can be used for this, which go beyond the scope of this disclosure since the actual technique used is unimportant. Having generated the MAC 308, it is appended to the packet and the signature is then removed. This results in a smaller payload 304′. Indeed, it makes the use of the previously described technique essentially costless in terms of bandwidth since the signature need not be provided as part of the memory access request.

The result is a packet where the MAC does not correspond with what is actually being transmitted, but instead corresponds with what would have been transmitted if the signature was present.

FIG. 4 illustrates how such a memory access request packet 300 can be received and the signature 306 can be implicitly obtained (e.g. obtained without it actually having been transmitted) by the check circuitry 136 for instance.

When the packet 306 is received, the physical address of the memory page is extracted and used to access the nonce storage circuitry 128 to obtain a current version of the nonce for that physical address. For instance, if the memory page 0x3F67800 was accessed, then the nonce ‘1’ would be obtained in the example of FIG. 4. This is the latest version of the nonce and therefore used to represent the latest set of permissions. The nonce is then used together with the private key k from the private key k storage circuitry 130 and the physical address of the requested memory page specified in the header of the packet 300 to form a signature. This signature represents the signature that should currently be used to access the specified memory page.

The signature is then combined with the header 302 and payload 304 of the received packet 300 to regenerate the packet—this time with the current signature. The result is checked against the MAC 308 provided in the received packet. That is, the same MAC algorithm is applied to the header 302 and payload 304 containing the newly generated signature to see if there is a match. If there is a match, then this means that the MAC was generated with the signature in place. In other words, it is evidence that the issuer apparatus 104 had a valid current version of the signature for the memory block being accessed.

If the MAC 308 does not match then this indicates that the issuer apparatus 104 did not have the signature or did not have the correct signature.

Based on this outcome, access to the requested memory page can be granted. For instance, if it is determined that the issuer apparatus 104 had the correct signature then access can be granted (the write performed, or the read returned) and if the correct, valid, current signature was determined not to have been present then the access can be refused.

It is therefore possible for the issuer apparatus 104 to provide evidence that it is in possession of the signature without providing the signature itself. This is achieved by providing a MAC that would only be correct if the correct signature was present. Since the issuer apparatus 104 cannot replicate the signature without owning it, it is not possible to produce the correct MAC without the presence of the signature.

An alternative to the above process is for the signature to actually be included in the packet. This process may be more secure because it acts as more of a guarantee that the signature is held by the issuer apparatus. However, it requires transmittal of the signature itself, which can increase bandwidth.

When such a packet is received, it is simple to confirm whether the issuer apparatus 104 is permitted to access the memory page. Either the signature provided in the received packet can be decrypted using the private key ‘k’ to read the value of the nonce and compare it to the corresponding current entry in the nonce storage circuitry 128 to see if there is a match (a match meaning that access is granted since the signature is the latest version) or a new signature can be generated using the latest nonce, and the signatures can be compared (again, a match meaning that the provided signature is the latest version).

Note that in practice, there are numerous items that can be either included or not included. The above technique is not limited to one item of implicit data. In these situations, the MAC is generated using both the data that is present and the data that is implicit and the receiver will have access to the implicit data to regenerate the MAC address to confirm accuracy of what is received. FIG. 5, which is made up from FIGS. 5A, 5B, and 5C illustrates a series of flowcharts 500, 508, 524 that show the processes performed by the issuer apparatus 104, translation apparatus 108, and access apparatus 110 respectively. At the issuer an optional step 502 may occur in which a translation request is received for the virtual address to a memory block. This request can be sent to the translation apparatus 108. The translation apparatus 108 in this example goes through a continual loop of listening for changes to the permissions of memory pages and if such a notification is received at step 510 then the nonce associated with the memory page is incremented at step 512 and the process returns to step 510. If no permission is changed then at step 514 it is determined whether a translation is received (e.g. from the issuer apparatus 104 in step 502). If not, the loop continues by returning to step 510.

At a step 516, it is determined whether the apparatus that requests the translation has suitable permission to access the memory page. If not, then an exception is raised at step 518. Otherwise at step 520, the current nonce for the memory page is acquired and a signature is generated by applying a cryptographic one-way hash to a combination of the physical address of the requested virtual address and the nonce, using a private key that is not provided to the issuer. The resulting signature is then transmitted together with the (unencrypted) physical address at step 522.

At step 504, the translation and the signature are received and may be stored for future access requests. At step 506, a memory access is made. This uses the physical address and the signature that were returned. The memory access request is made to an access apparatus 110. The memory access uses the physical address by either including it in the memory access request or, for instance, by using it to generate a MAC which is then included in the memory access request without the signature.

Then, at step 526, the memory access request (a read or write request) is received by the access apparatus, with the access request containing the physical address of the memory block to be accessed. At step 528, the access apparatus acquires the signature. This can either be by extracting it from the memory access request, generating it using the nonce, private key, and physical address, or by accessing an already generated signature from a cache that is provided to the access apparatus (e.g. by the translation apparatus). In any event, it is determined at step 530 whether the nonce that would have been (or was) in the signature matches a current value of the nonce. This could be determined by extension of determining whether the signature is valid. That is, if the received data access request cannot be generated using the most recent version of the signature (which contains the most recent version of the nonce) then the nonce is implicitly invalid. If the nonce is invalid then at step 532 an exception is raised. Otherwise at step 534, the access is granted (e.g. a write is performed, or the request data is read back to the issuer).

FIG. 6, which is made up from FIGS. 6A and 6B illustrate the process of implicitly including data in a packet using flowcharts 600, 608 as might be performed by the issuer apparatus 104 and the access apparatus 110.

The first flowchart 600 shows the process of generating the packet and may be carried out by the issuer apparatus 104. At a step 602, a first payload (e.g. a physical address) and a second payload (e.g. the signature) are obtained. At a step 604, a MAC is generated using at least the first payload and the second payload. Then, at a step 606, the packet is generated using the first payload and the MAC address, without including the second payload. The supplied MAC address will therefore not represent what is in the packet itself, but rather what is in the packet together with what is being implied to be in the packet.

The second flowchart 608 shows the process of decoding the packet and may be carried out by the access apparatus 110. Here, the packet containing the first payload (e.g. the physical address) and the MAC is received at step 610. As previously stated, the MAC does not directly correspond with the first payload. Then at step 612, the second payload is obtained from somewhere other than the packet. At step 614, the MAC is checked to determine that it corresponds with the combination of the first payload (from the packet) and the second payload, which is implied to be present in the packet. If so, then it is determined that the second payload was implicitly present in the packet that was sent, since without having the packet, the MAC could not be generated. Clearly in the process, the algorithm for producing the MAC is the same at both apparatuses.

FIGS. 7A, 7B, 7C, 7D, and 7E illustrate simulator implementations that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 702, 722, 742, 762, 782 optionally running a host operating system 704, 724, 744, 764, 784 supporting the simulator program 706, 726, 746, 766, 786. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 702, 722, 742, 762, 782), some simulated embodiments may make use of the host hardware, where suitable.

The simulator program 706, 726, 746, 766, 786 may be stored on a computer-readable storage medium (which may be a non-transitory medium), and provides a program interface (instruction execution environment) to the target code 708, 728, 748, 768, 788 (which may include applications, operating systems and a hypervisor) which is the same as the interface of the hardware architecture being modelled by the simulator program 706, 726, 746, 766, 786. Thus, the program instructions of the target code 708, 728, 748, 768, 788 may be executed from within the instruction execution environment using the simulator program 706, 726, 746, 766, 786 so that a host computer 702, 722, 742, 762, 782 which does not actually have the hardware features of the apparatus 108, 110, 104 respectively discussed above can emulate these features.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A translation apparatus comprising:
translation request receive circuitry configured to receive, from an issuer apparatus, a translation request for addresses used to access a block of a memory;
permission check circuitry configured to check permissions associated with the block of memory and produce a determination of whether the issuer apparatus is permitted to access the block of memory;
nonce storage circuitry configured to store a nonce in association with the block of memory; and
translation response circuitry configured to transmit a response to the translation request with one of the addresses used to access the block of memory and a signature corresponding with a current value of the nonce and the one of the addresses, in response to the determination that the issuer apparatus is permitted to access the block of memory, wherein
the nonce is changed in response to permissions of the block of memory being changed.

2. (canceled)

3. The translation apparatus according to claim 1, wherein
the nonce takes the form of a counter, which is changed in response to permissions of the block of memory being changed by incrementing the counter.

4. (canceled)

5. The translation apparatus according to claim 1, wherein
the signature is generated by performing a first one-way hash on the nonce and one of the addresses.

6. (canceled)

7. The translation apparatus according to claim 1, wherein
the translation response circuitry is configured to respond to a plurality of translation requests for the address from a plurality of issuer apparatuses by performing a plurality of checks on the permissions for the plurality of the issuer apparatuses, and transmitting the responses based on which of the issuer apparatuses is permitted to access the block of memory.

8. A data processing method comprising:
receiving, from an issuer apparatus, a translation request for addresses used to access a block of a memory;
checking permissions associated with the block of memory;
producing a determination of whether the issuer apparatus is permitted to access the block of memory;
storing a nonce in association with the block of memory; and
transmitting a response to the translation request with one of the addresses used to access the block of memory and a signature corresponding with a current value of the nonce and the one of the addresses, in response to the determination that the issuer apparatus is permitted to access the block of memory, wherein
the nonce is changed in response to permissions of the block of memory being changed.

9. (canceled)

10. An access apparatus comprising:
access request receive circuitry configured to receive, from an issuer apparatus, an access request to access a block of memory;
signature obtain circuitry configured to obtain a signature for the access request;
nonce storage circuitry configured to store a nonce in association with the block of memory;
check circuitry configured to perform a check of whether a current value of the nonce matches that used to generate the signature; and
grant circuitry configured to grant access to the block of memory in dependence on the check, wherein
the nonce is changed in response to permissions of the block of memory being changed.

11. The access apparatus according to claim 10, comprising:
encryption circuitry configured to encrypt data in the access request using the nonce, to produce encrypted data and to write the encrypted data to the block of memory in dependence on the check.

12. The access apparatus according to claim 10, comprising:
decryption circuitry configured to decrypt data retrieved from the block of memory using the nonce to produce decrypted data in dependence on the check.

13. The access apparatus according to claim 10, wherein
the access request comprises an address of the block of memory, and the signature; and
the signature obtain circuitry is configured to obtain the signature from the access request.

14. The access apparatus according to claim 10, comprising:
the signature is generated by performing a first one-way hash on an address of the memory block and the nonce, using a private key.

15. (canceled)

16. (canceled)

17. The access apparatus according to claim 10, wherein
the signature obtain circuitry is configured to obtain the signature implicitly from the access request.

18. The access apparatus according to claim 10, wherein
the access request received by the access request receive circuitry comprises an address of the block of memory and a Message Authentication Code, and omits the signature;
the Message Authentication Code is generated by performing a second one-way hash on access request variant comprising the address of the block of memory and the signature.

19. The access apparatus according to claim 18, wherein
the check circuitry is configured to perform the check by producing a test signature from the address of the block of memory and the nonce and by testing whether the Message Authentication Code corresponds with a result of performing the second one-way hash on the address of the block of memory and the test signature.

20. (canceled)

21. (canceled)

22. The access apparatus according to claim 10, wherein
the nonce takes the form of a counter, which is changed in response to permissions of the block of memory being changed by incrementing the counter.

23. (canceled)

24. (canceled)

25. A data processing method comprising:
receiving, from an issuer apparatus, an access request to access a block of memory;
obtaining a signature for the access request;
storing a nonce in association with the block of memory;
performing a check of whether a current value of the nonce matches that used to generate the signature; and
granting access to the block of memory in dependence on the check, wherein
the nonce is changed in response to permissions of the block of memory being changed.

26. (canceled)

27. An issuer apparatus comprising:
storage circuitry configured to store, in association with a block of memory, a signature corresponding with the block of memory; and
request circuitry configured to issue a memory access request to an access apparatus, wherein
the memory access request is to access the block of memory and the memory access request is generated using the signature;
the signature has been generated using a private key and a nonce that is specific to the block of memory; and
the nonce is changed in response to permissions of the block of memory being changed.

28. The issuer apparatus according to claim 27, wherein
the request circuitry is configured to generate the memory access request using the signature by including the signature in the request.

29. The issuer apparatus according to claim 27, wherein
the request circuitry is configured to generate the memory access request using the signature by generating a Message Authentication Code based on the memory access request including the signature; and
the request circuitry is configured to transmit the memory access request including the Message Authentication Code and omitting the signature.

30. (canceled)

31. (canceled)

32. (canceled)

33. The issuer apparatus according to claim 27, comprising:
translation request circuitry configured to transmit, to a translation apparatus, a translation request for addresses used to access the block of memory; and
translation response receive circuitry configured to receive an address used to access the block of memory and the signature.

34. (canceled)

35. (canceled)

36. A data processing method comprising:
storing, in association with a block of memory, a signature corresponding with the block of memory; and
issuing a memory access request to an access apparatus, wherein
the memory access request is to access the block of memory and the memory access request is generated using the signature;
the signature has been generated using a private key and a nonce that is specific to the block of memory; and
the nonce is changed in response to permissions of the block of memory being changed.

37. (canceled)

38. (canceled)

39. (canceled)

40. (canceled)

41. (canceled)

42. (canceled)

43. (canceled)
